(19) United States
(12) Patent Application Publication
(10) Pub. No.: US 2021/0063231 A1
(43) Pub. Date: Mar. 4, 2021

(54) STRUCTURAL EQUIPMENT LOAD MONITORING SYSTEM AND METHOD

(71) Applicant: Slingmax Technologies LLC, Wilmington, DE (US)

(72) Inventors: Gregory D'ELIA, Aston, PA (US); Scott ST. GERMAIN, Aston, PA (US); Christian CORNEJO, Aston, PA (US); Daniel ROSS, Aston, PA (US)

(21) Appl. No.: 16/950,438

(22) Filed: Nov. 17, 2020

Related U.S. Application Data
(62) Division of application No. 16/639,846, filed on Feb. 18, 2020.
(60) Provisional application No. 62/797,448, filed on Jan. 28, 2019.
(60) Provisional application No. 62/703,003, filed on Jul. 25, 2018.

(51) Int. Cl. G01G 19/18; D07B 1/14; D07B 1/02; D07B 1/16; G01G 23/36

(52) U.S. Cl. CPC G01G 19/18; D07B 1/145; D07B 2501/2015; D07B 1/162; G01G 23/36; D07B 1/025

(57) ABSTRACT

A system for monitoring loading of equipment includes a transmitter assembly mounted to the equipment and a central server. The transmitter assembly has a strain gauge secured to the equipment, an on-board controller and a battery. The central server is in communication with the on-board controller. The central server is configured to receive collected loading data from the transmitter assembly. The on-board controller is configured to operate the transmitter assembly in a load monitoring power mode and a deep sleep mode. The on-board controller is configured to operate at a sleep interval when a load measured by the strain gauge is less than ten percent of a rated working load of the equipment and at an active interval when the load measured by the strain gauge is greater than ten percent of the rated working load. The sleep interval is less than the active interval.

### CROSS-REFERENCE TO RELATED APPLICATIONS

The present application claims the benefit of U.S. Provisional Patent Application Nos. 62/703,003, filed on Jul. 25, 2018 and titled “Pre-Failure Warning Indicator System for a Sling or Rope and Related Method” and 62/797,448, filed on Jan. 28, 2019 and titled, “Structural Equipment Load Monitoring System and Method” the entire contents of which are incorporated herein by reference in their entirety.

### BACKGROUND OF THE INVENTION

Rigging and lifting equipment is subjected to unknown forces and loading from time to time. Many factors can cause unknown forces and loads, such as estimated weights due to missing documentation or an overload situation caused when a lift starts with a load inadvertently still connected to original supporting structures or other components. No matter how careful planning is, improper rigging can result from poor training, human error, or equipment failure. Over forty (40) people die each year in the United States in crane-related incidents based on lifting errors, a number that has remained constant for the last decade. This does not include other deaths and injuries from countless suspended loads encountered in industrial environments around the world. It is desirable to reduce such deaths and injuries by providing warnings to operators during overloads or potential overload situations.

Load-monitoring built into lifting and rigging hardware, especially, but not limited to shackles, is known in the rigging and construction trade. In current implementations, a user connects to the monitored hardware using a dedicated receiver, or possibly a commercially available wireless protocol, like Bluetooth. Once connected, the user starts a monitoring session, where they watch and/or record loads measured by the hardware in real time. Once the monitored lift is complete, the load monitoring system is shut down to save battery life.

Such systems work well for monitoring critical lifts where there are specific concerns, such as when lifting a very expensive/unique item, a load with unknown weight, a load having an awkward or unique shape, a lift in a difficult or unusual environment and related loads and scenarios. When the critical or unique lift is complete, the load monitoring hardware is stored until the next time it is needed and traditional, non-monitored hardware is put back in its place. These custom load monitoring systems increase safety and give lift planners insight into lifts in a way that they never had before. This approach, however, leaves two significant unknowns, including (1) how the equipment is loaded during every day “general” or common lifts and (2) the total use history of the piece of hardware or equipment that may encounter shock or impact loading, even during the “general” or common lifts. The existing systems and methods utilize hardware that is constantly and consistently collecting and transmitting loading data to a remote storage area, which results in quick depletion of the battery. Battery removal and replacement is undesirable for operators and may result in lifts that are not monitored, as the system does not operate when the on-board gauge and transmitter is not powered by the battery. The shock and impact loading during general lifts may also be below design loads, rated working loads or critical loads and even above design loads or rated working loads for short amounts of time, but operators currently have no system, mechanism or method for collecting and analyzing loading data for lifting equipment during general, everyday loadings. It is desirable to design, develop, implement and deploy a system that overcomes the deficiencies of the prior art load monitoring systems that is able to consistently acquire and store loading data and provide feedback to the user regarding loading of a particular piece of equipment, multiple loaded components and several remote lifting components and equipment located at various sites. These preferred systems and methods are particularly adapted for common lifting environments and are designed and configured for consistent load monitoring, data collection, data analysis and communication with the user during everyday, general lifting operations.

### BRIEF SUMMARY OF THE INVENTION

Briefly stated, the preferred invention is directed to a system for monitoring the loading of equipment and components utilized for lifting. The system includes a transmitter assembly mounted to the equipment having a strain gauge secured to the equipment at a predetermined loading path, an on-board controller and a battery. The system also includes a central server in communication with the on-board controller. The central server is configured to receive collected loading data from the transmitter assembly that is measured by the strain gauge and collected by the on-board controller. The on-board controller is configured to operate the transmitter assembly in a load monitoring power mode and a deep sleep mode. The on-board controller is configured to operate at a sleep interval when a load measured by the strain gauge is less than ten percent of a rated working load of the equipment and components and at an active interval when the load measured by the strain gauge is greater than ten percent of the rated working load. The sleep interval is less than the active interval.

The load monitoring system of the preferred embodiment may, in addition to monitoring loads and collecting load data during a lift, manage the operational status and condition of the rigging inventory or hardware by monitoring individual components, such as by monitoring whether a specific sling has encountered a load greater than its rated load. A lift does not have to overload the crane, or even most of the rigging and slings, to result in a compromised sling. If a sling is shorter than required, or if a sling becomes snagged or hung up during use, it is possible the specific sling is overloaded while the rest of the slings in the lift are not overloaded. At a conventional jobsite, the sling that is overloaded or the sling that is subjected to a load greater than its overload would go back into a storage area to be used by the next rigger. When utilizing the preferred load monitoring system, the overloaded sling would send a signal to a base station alerting the user that there is an issue, particularly that the sling has been subjected to an overload condition or a load greater than its rated load. If the user ignores the warning, the next time the preferred load monitoring system starts and connects to the overloaded sling, the overload warning again will be displayed to the operating personnel based on a message from the base station, thereby giving the next user an opportunity to remove the overloaded sling from service for inspection and repair. The overload is detected by a sacrificial strand breaking, which is detected by a break in signal at a pair of continuity detection leads. The break of the sacrificial strand and detachment or break in signal of the continuity detection leads results in transmittal of signal from the transmitter assembly to the base station. The base station also communicates with a user's mobile device, such as a mobile phone, laptop, smartphone, desktop computer, tablet computer or related device that indicates the overload condition of the specific sling or other lift hardware.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a side perspective view of a load monitoring system with example components and equipment in accordance with a preferred embodiment of the present invention;

FIG. 1A is a magnified side perspective view of the load monitoring system of FIG. 1, taken from within circle 1A of FIG. 1;

FIG. 1B is a magnified side perspective view of the load monitoring system of FIG. 1, taken from within circle 1B of FIG. 1;

FIG. 1C is a magnified side perspective view of the load monitoring system of FIG. 1, taken from within circle 1C of FIG. 1;

FIG. 2 is a diagram of the preferred load monitoring system of FIG. 1;

FIG. 3 is a top perspective view of an alternative preferred transmitter assembly of the load monitoring system of FIG. 1;

FIG. 4 is a load monitoring top plan view of the transmitter assembly of FIG. 3; and

FIG. 5 is a top perspective view of a synthetic roundsling which may be utilized with the load monitoring system of FIG. 1.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The words “inwardly” or “distally” and “outwardly” or “proximally” refer to directions toward and away from, respectively, the geometric center or orientation of the load monitoring system, instruments and related parts thereof. The terminology includes the above-listed words, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

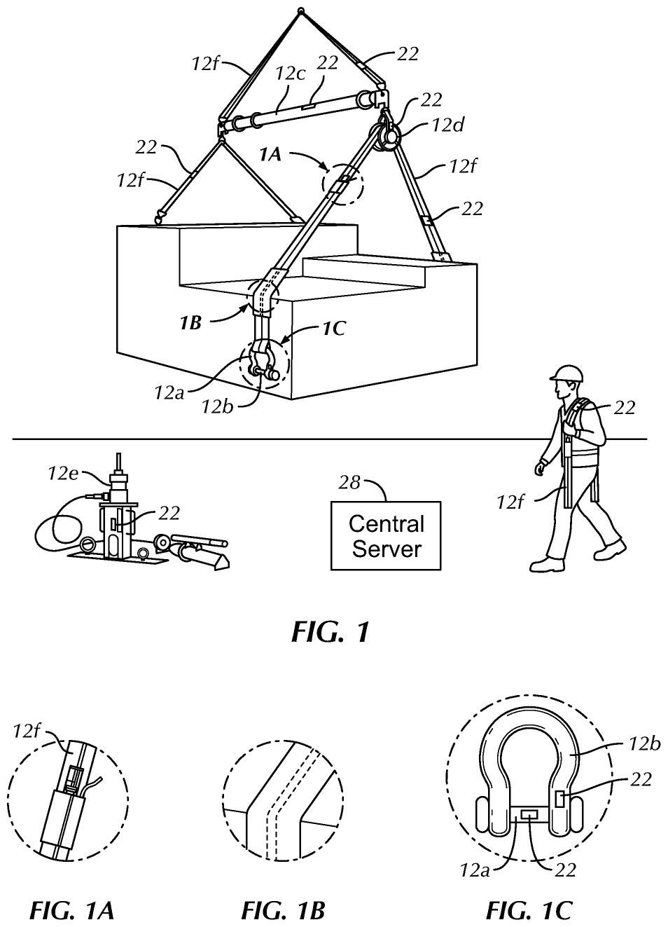

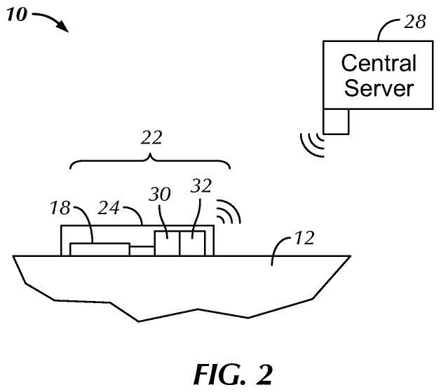

Referring to FIGS. 1-3, the preferred load monitoring system, generally designated 10, addresses limitations of known technology for measuring loading data for structural equipment, preferably lifting equipment and components, and facilitates tracking and analysis of the loading encountered by the equipment and components during operation of the equipment and components, preferably during lifts. The preferred system 10 provides information or feedback during operation of the equipment and components, preferably to determine if a piece of hardware, equipment or related components is overloaded when it is not being actively monitored by a user, if the equipment or component is approaching fatigue limitations or additional structural benchmarks are reached or exceeded during normal operation.

In the preferred embodiment, the system 10 operates with a piece of hardware, which may comprise nearly any structural equipment or components, such as a shackle pin 12a, a shackle 12b, a spreader bar 12c, a turnbuckle, a hook, a block, a rigging block or equalizer block 12d, a pad eye tester 12e, a sling 12f, a crane and related equipment and components. The equipment and components are generically designated herein by reference numeral 12. The hardware 12 preferably has a transmitter assembly 22 mounted thereto, which preferably includes a strain gauge 18 mounted to the hardware 12, either internally or externally. There is also preferably a controller or ultra-low power microcontroller 30 and a battery 32 that are mounted within a housing 24 and attached to or embedded in the hardware 12. The strain gauge 18 is preferably mounted at an expected load path on the hardware or equipment 12 such that relatively significant or maximum loads that are carried by the equipment 12 are measured by the strain gauge 18 during use. The controller 30 reads the signals from the strain gauge 18, process the signals, and send the signals, preferably wirelessly, to a central server or base station 28 for storage, analysis, display, distribution to a central processing server and/or distribution to users, monitors or related personnel.

The controller on-board computer system 30 of the transmitter assembly 22 preferably has the ability to enter different levels of sleep mode in order to preserve battery life of the battery 32 that powers the transmitter assembly 28, including the strain gauge 18. The main functions of the system 10 that impact battery life of the batteries 32 include (1) monitoring the loads on the strain gauges 18 and (2) communications with a receiver at a central server 28. These two main power scenarios can be managed separately by the on-board controller 30 or the central server 28 and are referred to herein as (1) the load monitoring power mode and (2) the communication power mode.

For the load monitoring power mode, a load threshold is preferably set so that when the load measured by the strain gauges 18 is less than the load threshold, which is preferably some percentage of the rated working load of the hardware or equipment 12, for example, ten percent (10%) of the working load, the on-board controller 30 operates in a deep sleep mode, checking the load at preset or variable intervals, such as every sixty seconds (60 sec).

When a load is acquired by the strain gauge 18 and sent to the on-board controller 30 during the deep sleep mode at a level above the load threshold, the system 10 changes to a more frequent load sampling interval, because it can be inferred that an active lift is happening or the particular piece of equipment or related components 12 are being used. For example, the system 10 could begin to sample at intervals of once every two seconds (2 sec) when the applied load of load applied to the hardware of equipment is above the load threshold of ten percent (10%) of the working load. The determination to change modes and sampling intervals is preferably determined by the on-board controller 30, but may be driven by the central server 28.

For an even greater level of battery power management, additional thresholds can be set with different sampling intervals. For example, the controller 30 may have a first preset load threshold of ten to fifty percent (10-50%) of rated working load of the equipment 12 where a first sampling rate could be every two seconds (2 sec), a second preset load threshold from fifty to eighty percent (50-80%) of rated working load where a second sampling rate could increase to once every second (1 sec) and a third present load threshold over eighty percent (80%) of rated working load where a third sampling rate could increase further to once every one-half second (½ sec). These sampling rates, load thresholds and percentages of working loads are preferred examples, and the load thresholds and sampling rates could be almost anything that the factory or a user sets depending on user preferences, criticality of the equipment or components 12 being monitored, operating conditions or other factors related to the designer or the equipment 12. In this preferred example, the first load threshold is less than the second load threshold and the second load threshold is less than the third load threshold. Further, in this preferred example, the third sampling rate results in load data collection more frequently than the second sampling rate and the second sampling rate results in load data collection more frequently than the first sampling rate. The power of the battery 32 is thereby preserved in low or no load situations of the hardware 12, because the first sampling rate is less frequent, thereby reducing the load data collected and the transmittal of load data to the central server 28 when the hardware 12 is not loaded. The system 10, however, is able to collect appropriate volumes of loading data when the hardware 12 is loaded by increasing the sampling rate to the third sampling rate when the hardware 12 is subjected to loads at or above the third threshold load. The user may alternatively send a signal to the transmitter assembly 22 indicating that there hardware 12 will be imminently loaded and the sampling rate should be increased for detection of the loadings during operation. In addition, a signal may be sent to the transmitter assembly 22 by the user indicating that there is no expected loading on the hardware 12 so that the sampling rate or interval may be decreased to longer intervals.

In addition to checking the load, the on-board controller 30 preferably transmits loading data at predetermined intervals to a receiver at the central server 28. In this operating mode, the loading data, preferably strain data from the strain gauge 18, is transmitted at load transmission intervals that may be either the same interval as the sampling interval or at a different interval. The load transmission interval can also be manipulated to preserve battery life. If the on-board controller 30 does not detect a receiver in the area that is able to accept the transmitted loading data or is unable to communicate with the central server 28 for nearly any reason, this lack of communication with the receiver can be another criteria for staying at a deep sleep mode for transmitting. The on-board controller 30 preferably makes the determination regarding whether to stay in the deep sleep mode when unable to communicate with the central server 28. For example, if the on-board controller 30 tries to connect to a receiver of the central server 28 and is unable to connect, the on-board controller 30 can direct the transmitter to hold for sixty seconds (60 sec) before attempting a subsequent transmittal of loading data. Additionally, if the transmitter or on-board controller 30 cannot connect to a known receiver after a certain amount of attempts at sixty second (60 sec) intervals, the on-board controller 30 and transmitter may move to a longer period of time or interval before attempting additional transmissions, such as ten minutes (10 min). The on-board controller 30 and transmitter may also use a real-time clock and/or calendar to determine a load data transmission interval. For example, if a user or operator does not have a second or third working shift wherein the equipment and components 12 are typically not utilized during the second and third shift times of day, the on-board controller 30 could transmit to the central server 28 every sixty seconds (60 sec) during normal operation, for example, from seven (7) AM-three (3) PM, Monday-Friday, but move to a ten minute (10 min) load transmission interval during nights and weekends, as well as preferably on known work holidays. This reduced load data transmittal may be interrupted or increased when the on-board controller 30 detects loading at or above the load threshold, such as the first, second or third load threshold, and more frequently transmit the load data when the load thresholds are exceeded.

If the on-board controller 30 is out of communication with the receiver of the central server 28, but the on-board controller 30 is recording load from the strain gauge 18, the on-board controller 30 preferably has storage capability to save the loading data in an on-board storage database. In order to save storage space, some data analysis could be done in the on-board controller 30 that is attached to the hardware or equipment 12. For example, if the load sampling rate is once every second, but the load is stable within a five percent (5%) range for several minutes, many of the duplicate data points of the collected loading data could be discarded. For example, one in every ten data points or recorded loads could be stored in the controller 30 while the duplicate loads that provide the same consistent loading is stored in the storage database. The data processing could be controlled by an algorithm where additional loading data is saved if there is a predetermined relatively large variability in the load and loading data is saved when the load data is more stable or consistent.

When the on-board controller 30 resumes communications with a receiver of the central server 28, the load data is subsequently sent for review, storage in a server database and analysis at the central server 28. The loading data may be stored at the storage database, at the server database, on a server anywhere on the internet or otherwise located, as long as the loading data can be retrieved, analyzed and transmitted in accordance with the normal operating configuration of the preferred system 10.

In addition to detailed load information, an all-time peak load that the equipment 12 carries is preferably saved to the on-board controller 30. When a piece of the hardware or equipment 12 is overloaded beyond the rated working load, permanent damage is possible. While an engineer or lift director may be interested in specific detailed records of lifts that have happened, an average user may just want to know if the piece of hardware 12 was ever overloaded or loaded over its rated working load during its operating lifetime. By reading this peak load, the user could quickly determine if the hardware 12 was potentially damaged due to overload during nearly any time period of its working life. The user could read this peak load by connecting to the on-board controller 30 with a receiving device or the user could manipulate a button on the housing 24 that is pressed, which illuminates an light emitting diode (“LED”) (not shown) on the housing 24 to display the peak load and the. The LED may also be designed and configured such that a green color is displayed for a piece of equipment 12 that has never been overloaded, and another LED is red if the on-board controller 30 or the storage database has a load therein that exceeds the threshold load. If the indicator alerts the user to an overload, either via the LED or another manner, such as a direct message to the user or manager, the user or manager could take the equipment 12 out of service and the loading profile could be analyzed to determine if the equipment 12 is fit for continued use, may require repair or refurbishment or must be taken out of service.

In the preferred embodiment, the load monitoring system 10 monitors loading of multiple hardware 12 components during a lift, including the spreader bar 12c, the slings 12f, the shackle pin 12a and the shackle 12b. The on-board controllers 30 collect operating loads from the strain gauges 18 based on the operating mode of the equipment or hardware 12

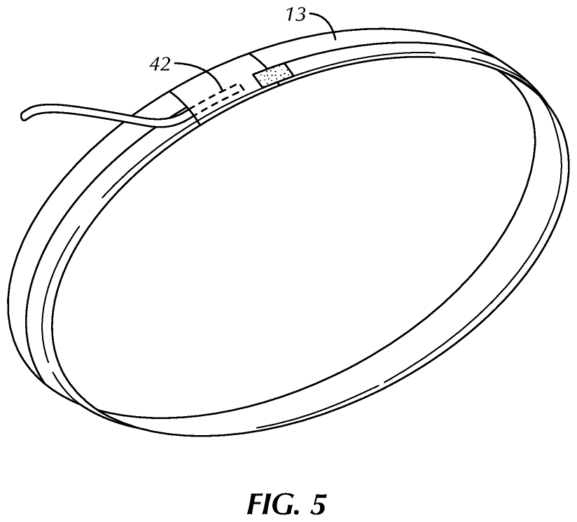

Referring to FIGS. 1-5, the preferred load monitoring system 10 is particularly adapted for use with the slings 12f, which are preferably comprised of synthetic slings 12f The synthetic slings 12f exploit the use of synthetic fiber core yarns and their mechanical properties in tension. High-performance synthetic fibers used in lifting slings 12f are resistant to many chemicals and have high mechanical strength, high elastic modulus, and high strength-to-weight ratio among many other advantageous properties. A protective cover 13 is positioned over and around the synthetic fibers and prevents damage to the load-bearing yarn from external abrasion, thereby extending the life of a synthetic roundsling 12f. In the preferred sling 12f, the protective cover 13 is comprised of a highly durable, protective nylon jacket. The sling 12f preferably also includes twin path fiber core yarns that are positioned inside the protective cover 13.

The preferred load monitoring system 10 allows users to monitor their lifts, particularly the slings 12f, safely with real-time feedback and at a distance. The preferred load monitoring system 10 increases visibility regardless of lighting, weather, or distance, provides real-time feedback on the condition of the slings 12f and provides accountability and traceability via alerts and a history log, particularly for individual slings 12f. The load monitoring system 10 preferably provides continuous monitoring of the condition or loading of the hardware 12, provides a significant amount of life, preferably at least one (1) year, for the battery 32, facilitates significant range of communication, preferably approximately one hundred fifty meters (150 m) or five hundred feet (500 ft), between the transmitter assembly 22 and base station 28, the ability to monitor a plurality of hardware 12, such as at least fifty (50) slings 12f at one time by the base station 28, and delivers a signal to the base station 28 from the transmitter assembly 22 quickly after an overload event, preferably within several seconds, such as within about two to ten seconds (2-10 sec).

The preferred load monitoring system 10 communicates in the industrial, scientific and medical (“ISM”) bands for radio communications between the transmitter assembly 22 and the base station 28. Operation in the ISM bands facilitate operation in the typical rigging environment where obstruction, high frequency interference, and distance for safety are likely. The ability to monitor multiple hardware 12 at one time is advantageous from a site management perspective, where multiple hardware 12 and associated transmitter assemblies 22 are in use, or in inventory. The load monitoring system 10 facilitates use and communication of multiple transmitter assemblies 22 to monitor multiple rigging hardware 12.

The load monitoring system 10 of the preferred embodiment utilizes a frequency-hopping spread spectrum implementation, although is not so limited and may utilized other communication implementations, such as Bluetooth, Wi-Fi, Sub-GHZ or other protocols for communication between the transmitter assembly 22 and the base station 28 or between the base station 28 and the user's personal computing device. The permitted power is higher when using hopping versus narrow band direct transmission since the potential interference is spread out over a minimum number of channels (with defined dwell times and band spacing). In the preferred load monitoring system's 10 communication between the transmitter assemblies 22 and the base station 28, the radio channel regularly switches in a sequence governed by the base station 28 upon power up. The plurality of transmitter assemblies 22 synchronize and hop in sequence with the base station 28 during operation. This spread spectrum technique of communication provides an increased resistance to narrow band interference, since the interfering signal is diluted during signal collection for communications between the transmitter assemblies 22 and the base station 28. If another device is present on the same bandwidth, the potential of interference lasts only if the two devices coexist on similar channels. Because the load monitoring system 10 is constantly hopping, potential interference is only momentary and subsequently hops where interference is alleviated. Additionally, multiple base stations 28 can coexist at a single site without the need to differentiate channels since the base stations 28 and their respective transmitter assemblies 22 can hop out of sync with each other.

In the preferred embodiment, the communication between the base stations 28 and the transmitter assemblies 22 operate on approximately the nine hundred fifteen megahertz (915 MHz) ISM band, which gives the load monitoring system 10 advantages over devices on the two and four tenths gigahertz (2.4 GHz) band. For example, the preferred system 10 generally avoids the crowding from Bluetooth and Wi-Fi devices present on the two and four tenths gigahertz (2.4 GHz) band and the Bluetooth and Wi-Fi band may also be subject to interference from stray signals from microwave ovens and other appliances on the bandwidth. On a rigging jobsite, devices such as pendants and other wireless controls also communicate on the two and four tenths gigahertz (2.4 GHz) bandwidth, thereby potentially causing additional interference. Further, the preferred lower frequencies used for communication between the base station 28 and the transmitter assemblies 22 can more easily pass through physical objects, thereby providing greater range to monitor from an extended distance and more flexible jobsite locations. Ensuring a strong signal is key to maintaining reliable communication between the transmitter assemblies 22, the base stations 28 and, ultimately, the users and operators.

In operation of the preferred load monitoring system 10, when the base station 28 is powered, the base station 28 preferably begins to broadcast a signal to any transmitter assembly 22 within its reachable range. When the transmitter assemblies 22 are not connected to or in communication with the base station 28, the transmitter assemblies 22 are consistently sending signals and awaiting a signal from the base station 28. Both the base stations 28 and the transmitter assemblies 22 follow a predetermined sequence in the ISM bands to search of each other. When in range of the base station 28, the transmitter assembly 22 preferably finds or establishes communication with the base station's 28 signal within a relatively short amount of time, such as approximately two to ten minutes (2-10 min.) and more preferably within about five minutes (5 min). Once the base station 28 and the transmitter assembly 22 establish communication, the transmitter assembly 22, via the microcontroller 28, knows where it is on the frequency-hopping sequence and synchronizes its frequency-hopping with the respective base station 28. The transmitter assembly 22 and the base station 28 subsequently follow the same pattern of frequencies, so that the transmitter assembly 22 and the base station 28 are in relatively constant communication.

An unpaired transmitter assembly 22 preferably broadcasts or sends a signal every approximately twenty to sixty seconds (20-60 sec), more preferably approximately every thirty seconds (30 sec) searching for and attempting to establish communication with or alert the base station 28 that it is ready to be paired. When ready to add the transmitter assembly 22 or establish communication to the base station 28, a user may start the pairing process via a user interface or the transmitter assembly 22 may automatically establish communication with the base station 28. Unpaired transmitter assemblies 22 in the communication range preferably appear on a pairing screen of the user's computing device, and the user can then select the transmitter assemblies 22 for assignment to the base station 28. When the transmitter assembly 22 is paired with the base station 28, the transmitter assembly 22 starts a stream of communication with the base station 28. If the transmitter assembly 22 detects that the hardware 12, such as the sling 12, is in good condition, the transmitter assembly 22 sends a “normal” signal to the base station 28 at a regular interval, such as every thirty seconds (30 sec). This communication allows for a positive confirmation between the base station 28 and the transmitter assembly 22 that a wireless link is maintained, and the transmitter assembly 22 is in good condition. If and when the transmitter assembly 22 detects an overload, the transmitter assembly 22 immediately sends out an “overload” signal to the base station 28 and repeats sending that signal at an increased interval, such as every three seconds (3 sec) or at an interval greater than the regular interval. The increased reporting interval is preferred to ensure that if there is interference in the connection between the base station 28 and the transmitter assembly 22, the overload message is received by the base station 28 as soon as possible on the next reporting. Once the base station 28 receives the overload signal, the base station 28 preferably, although not necessarily, sends an acknowledgment signal back to the transmitter assembly 22, resetting the transmitter assembly 22 back to the regular interval, which is preferably every thirty second (30 sec) reporting interval to preserve the life of the battery 32. The transmitter assembly 22, however, preferably continues to report the overload condition for the rest of its field deployment or at least until the associated hardware 12 is inspected, repaired or replaced. The overload signal from the respective transmitter assembly 22 may reset to normal when the hardware 12 is returned to the factory, assuming the hardware 12 passes a factory inspection and proof-load test. The transmitter assembly 22, in addition to the overload condition and normal condition of the hardware 12 also preferably is able to provide additional information to the base station 28, such as hardware serial number, length of the sling 12f, part number of the hardware 12, capacity of the hardware 12, battery life of the transmitter assembly 22, type of hardware 12 associated with the transmitter assembly 22 and additional information related to the transmitter assembly 22 or hardware 12.

The preferred load monitoring system 10 preferably operates on a continuous monitoring principle, with power management handled by the microcontroller 30 that utilizes controlled, intermittent transmission. Continuous communication between the base station 28 and the transmitter assemblies 22 facilitates acknowledgment of transmission and results in a robust system 10 able to provide the user with real-time updates based on variable conditions. The continuous communication reduces the possibility of false positives because of equipment malfunction, loss of signal, or power loss in the case of battery depletion. Communication of the system 10 is preferably handled through a “star” network, where the base station 28 communicates with a multitude or plurality of transmitter assemblies 22. The base station 28 is preferably capable of direct communication with up to fifty (50) transmitter assemblies 22 or fifty (50) slings 12f at any one time.

Synchronization between the transmitter assemblies 22 and the base station 28 on the jobsite is preferred since the transmitter assemblies 22 frequency hop, but synchronization preferably only requires completion when the base station 28 loses power through power down or other means or during original set-up. Synchronization of the base station 28 with any given transmitter assembly 22 is preferably established through a pairing sequence, during which synchronized transmitter assemblies 22 broadcast join requests that enable the user to assign jobsite transmitter assemblies 22 that are associated with a particular hardware 12 to a given base station 28. Any interruption due to application or hardware shutdown or reboot of the base station 28 preferably causes paired transmitter assemblies 22 to automatically resynchronize and transmit to the associated base station 28 when the interruption is corrected. This set-and-forget setup typically does not require users to manage the transmitter assemblies 22 once a lift is configured. The base stations 28 and corresponding transmitter assemblies 22 can also be set from the factory as a default for communication with each other.

The base station 28—transmitter assembly 22 regular interval is approximately thirty seconds (30 sec) provided that the respective transmitter assembly 22 detects a continuous signal through the microcontroller 30 indicating that the hardware 12 is functionally operational or has not been subjected to an overload. Preferably at any time, a user can remotely verify through their personal computing device that is in communication with the base station 28 if the assorted hardware 12 is operating normally, is not subject to an overload and is in communication with the base station 28. If the standard communication interval or regular interval is interrupted, the base station 28 preferably reports a communication loss alert signaling to the user's computing device. This alert can be the result of hardware failure, loss of signal completely, depleted battery power, a significant amount of interference that is preventing timely communication between the base station 28 and the transmitter assembly 22 or for other communication issues.

The protocol of the preferred load monitoring system 10 is preferably designed to operate continuously, although is not limited to so operate, for twenty-four hours (24 hrs) a day, as long as an operational base station 28 and sufficient power are present. In addition, in the event of a drop in communication between the base station 28 and the transmitter assemblies 22, the transmitter assemblies 22 preferably resynchronize automatically with their respective base station 28 when the base station 28 again begins operation and the transmitter assemblies 22 preferably report their status once communication is again established.

In the preferred embodiment, the transmitter assemblies 22 are powered by the battery 32, which are comprised of two lithium-thionyl chloride (LTC) batteries 32. The battery 32 is not limited to the two LTC batteries and may be comprised of nearly any variety of battery 32 that is able to provide the preferred functions of the battery 32, withstand the normal operating conditions of the transmitter assemblies 22 and take on the general size of the battery 32. The batteries 32 are preferably, although not limited, to having high density, low self-discharge (with or without load), and have good performance in the product's temperature range of approximately negative forty degrees Centigrade to forty-nine degrees Centigrade (−40° C. to 49° C. or −40° F. to 120° F.).

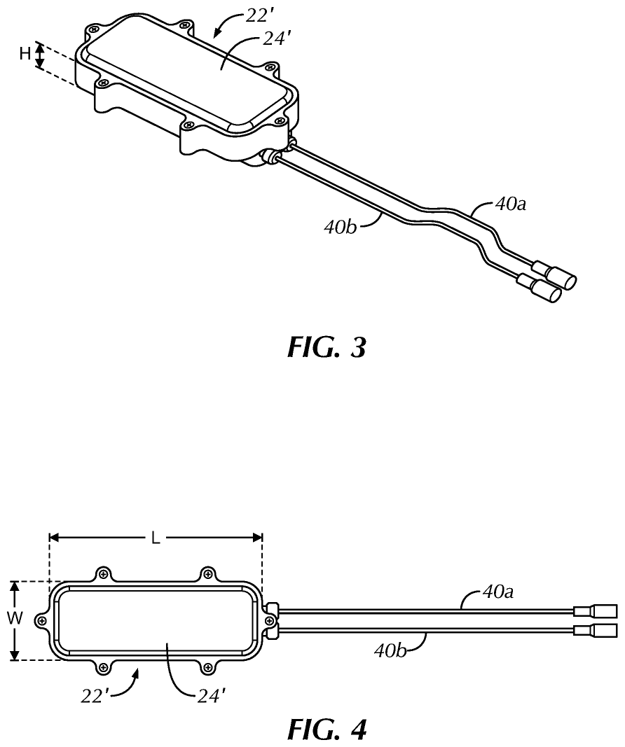

Referring specifically to FIGS. 3-5, an alternative preferred transmitter assembly 22′ has similar features when compared to the transmitter assembly 22 and like reference numbers are utilized to identify and describe like features with a prime symbol (′) utilized to distinguish the alternative preferred transmitter assembly 22′ from the first preferred transmitter assembly 22.

The alternative preferred transmitter assembly 22′ includes the housing 24′, which is comprised of upper and lower housing portions that surround and enclose the microcontroller 30 and battery 32. In addition, continuity detection leads 40a, 40b extend out of the housing 24′. The alternative preferred transmitter assembly 22′ is particularly adapted for use with the synthetic slings 12f having the protective cover 13 and the internal twin path fiber core yarns. The continuity detection leads 40a, 40b are connected to a sacrificial strand 42 that carries substantially the same loads as the fiber core yarns, but is designed to fail at a sacrificial strand load that is greater than the rated load of the sling 12f, such as two and one-half to three and one-half (2½-3½) times greater than the rated load of the sling 12f. The sacrificial strand load is, however, less than the ultimate load or capacity of the sling 12f, wherein the rated load is typically approximately five times less than the ultimate load. The sling 12f may, therefore, be load tested before being deployed by applying a load at least two times greater than the rated load without failure of the sacrificial strand 42 and at a load well below the ultimate load of the sling 12f.

The sacrificial strand 42 is preferably constructed of a conductive material, such as a nickel clad fiber that extends around the roundsling 12f and the continuity detection leads 40a, 40b are electrically connected to the sacrificial strand 42 such that the continuity detection leads 40a, 40b lose electrical connection when the sacrificial strand 42 breaks under a load greater than the rated load. The continuity detection leads 40a, 40b are preferably connected to the sacrificial strand 42 by screw post wire connectors, but are not so limited and may be adhesively bonded, welded, soldered, clamped, fastened or otherwise secured to the sacrificial strand 42 to facilitate conduction of an electrical signal through the connections of the sacrificial strand 42 with the continuity detection leads 40a, 40b. When the continuity detection leads 40a, 40b lose connection, the microcontroller 30 sends a signal to the base station 28 that the sling 12f has been subjected to an overload and functions as is described above. In addition, when the continuity detection leads 40a, 40b maintain conductivity through the sacrificial strand 42, the transmitter assembly 22′ sends signals to the base station 28 that the sling 12f is operating at or below rated load.

The preferred sling 12f has a minimum width of approximately three inches (3″) and the alternative preferred housing 24′ is designed to be as compact as possible to fit into the protective cover 13 of the sling 12f. The housing 24′ is preferably position within the protective cover 13 between the load-bearing core yarns of the sling 12f, preferably secured to the protective cover 13 or the core yarns. The housing 24′ is preferably secured within the protective covering 13 with the continuity detection leads 40a, 40b secured to the conductive sacrificial strand 42. This fit preferably allows the fabricator to sew the housing 24′ in place within the protective cover 13 in the sling 12f. The preferred housing 24′ has a height H of approximately one and one-half inches (1½″), a width W of approximately two and one-quarter inches (2¾″) and a length L of approximately five inches (5″). Embedding the housing 24′ underneath several layers of textile protection including the protective cover 13 and adjacent the core years inside the roundsling 12f reduces potential damage from impact, chemicals, ultraviolet light, abrasion and related potential damage.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the present disclosure.

I/We claim:

1. A system for monitoring the loading of equipment and components utilized for lifting, the system comprising:
a transmitter assembly mounted to the equipment having a strain gauge secured to the equipment at a predetermined loading path, an on-board controller and a battery; and
a central server in communication with the on-board controller, the central server configured to receive collected loading data from the transmitter assembly that is measured by the strain gauge and collected by the on-board controller, the on-board controller configured to operate the transmitter assembly in a load monitoring power mode and a deep sleep mode, the on-board controller configured to operate at a sleep interval when a load measured by the strain gauge is less than ten percent of a rated working load of the equipment and components and at an active interval when the load measured by the strain gauge is greater than ten percent of the rated working load, wherein the sleep interval is less than the active interval.

2. The system of claim 1, wherein the sleep interval is sixty seconds.

3. The system of claim 1, wherein the active interval is two seconds.

4. The system of claim 1, wherein the on-board controller is configured to transmit the collected loading data to the central server at a load transmission interval.

5. The system of claim 4, wherein the load transmission interval is that same as one of the sleep interval and the active interval.

6. The system of claim 4, wherein the on-board controller is configured to extend the load transmission interval when the on-board controller is unable to communicate with the central server.

7. The system of claim 1, further comprising:
a peak load display attached to the transmitter assembly, the peak load display in communication with the on-board controller, the on-board controller configured to save an all-time peak load measured by the strain gauge during the operating life of the equipment and components, the peak load display configured to display the all-time peak load when actuated by a user.

8. The system of claim 7, wherein the on-board controller stores a rated working load for the equipment and components, the peak load display configured to illuminate a green color when the all-time peak load is less than the rated working load and a red color when the all-time peak load is greater than the rated working load.

9. The system of claim 7, wherein the peak load display is also configured to display a rated working load when actuated by the user.

10. The system of claim 1, wherein the equipment and components is comprised of one of a shackle pin, a shackle, a spreader bar, a turnbuckle, a hook, a block, rigging block, an equalizer block, a pad eye tester, a sling, and a crane.

11. A system for monitoring a synthetic sling having a protective cover, core yarns and a conductive sacrificial strand, the system comprising:
a transmitter assembly including a housing, a battery, a first continuity detection lead and a second continuity detection lead, the first and second continuity detection leads configured for connection to the sacrificial strand; and
a base station in communication with the transmitter assembly, the base station in communication with the transmitter assembly at a regular interval during normal operation, the transmitter assembly communicating at an increased interval when a connection loss is detected between the first and second continuity leads and the sacrificial strand.

12. The system of claim 11, wherein the regular interval is approximately thirty seconds.

13. The system of claim 11, wherein the increased interval is approximately three seconds.

14. The system of claim 11, wherein the sacrificial strand is comprised of a nickel clad synthetic fiber strand.

15. The system of claim 11, wherein the transmitter assembly communicates with the base station on an ISM band.

16. The system of claim 15, wherein the transmitter assembly synchronizes its with the base station based on a frequency-hopping protocol.

17. The system of claim 15, wherein communication between the transmitter assembly and the base station is based on a frequency-hopping spread spectrum implementation.

18. The system of claim 11, further comprising:
a user computing device in communication with the base station based on one of a Wi-Fi and a Bluetooth protocol.

19. The system of claim 11, wherein the battery is comprised of two lithium-thionyl chloride batteries.

20. The system of claim 11, wherein the first and second continuity detection leads extend out of the housing.
